(19) United States
(12) Patent Application Publication
(10) Pub. No.: US 2026/0296473 A1
(43) Pub. Date: Oct. 1, 2026

(54) DRIVING ASSISTANCE DEVICE, DRIVING ASSISTANCE METHOD, AND PROGRAM

(71) Applicant: HONDA MOTOR CO., LTD., Tokyo (JP)

(72) Inventors: Yuko Sugimura, Tokyo (JP); Shunsuke Michita, Tokyo (JP); Mineyuki Yoshida, Tokyo (JP); Takuma Kobayashi, Tokyo (JP)

(21) Appl. No.: 19/549,023

(22) Filed: Feb. 25, 2026

(30) Foreign Application Priority Data
Mar. 31, 2025 (JP) 2025-057665

(51) Int. Cl. B60W 50/14; B60W 30/182; B60W 50/08; G06V 20/59

(52) U.S. Cl. CPC B60W 50/14; B60W 30/182; B60W 50/082; G06V 20/597

(57) ABSTRACT

A driving assistance device includes: a recognition part that recognizes a surrounding situation of a vehicle; an information terminal that is used by a specific person associated with a driver of the vehicle; and a driving controller that controls one of or both acceleration/deceleration and steering of the vehicle. The driving controller includes a mode determination part that determines a driving mode in which the vehicle is caused to travel with any of a plurality of kinds of driving assistance imposing different tasks on the driver, a judgment part that determines whether or not the driver is responding to a task, and an execution part that activates a warning in a case where the judgment part determines that the driver is not responding to the task. The execution part transmits information related to a behavior of the driver at a predetermined time before and/or after the warning is activated along with warning information to the information terminal.

### CROSS-REFERENCE TO RELATED APPLICATION

Priority is claimed on Japanese Patent Application No. 2025-057665, filed Mar. 31, 2025, the content of which is incorporated herein by reference.

### BACKGROUND OF THE INVENTION

### Field of the Invention

The present invention relates to a driving assistance device, a driving assistance method, and a program.

### Description of Related Art

In recent years, there have been increasing attempts to provide access to sustainable transportation systems that take into consideration the most vulnerable traffic participants. In order to realize this, research and development aim to further improve traffic safety and convenience through research and development of driving assistance technology. With distribution of autonomous driving/advanced driving assistance systems, a safe, secure, and comfortable mobility society has been expected to be realized. However, the fact that an increasing number of drivers are becoming overconfident in, abusing, or misusing safe driving assistance functions has been pointed out. Therefore, measures are needed to encourage drivers to use driving assistance functions correctly.

For example, Patent Document 1 (WO 2020/188634) discloses that whether or not a warning is effective for a driver is determined on the basis of a change in driver's state before and after the warning output from a warning device or a change in driver's driving operation of a vehicle after the warning. In addition, Patent Document 2 (U.S. Patent Publication No. 2017/0032673) discloses that driver's driving behavior information is provided as warning information to drivers of other vehicles within a predetermined distance of the vehicle.

### SUMMARY OF THE INVENTION

In a case where a driver (operator) abuses or misuses driving assistance functions and a warning is activated, the driver and fellow passengers may not understand the reason for the warning. In order to improve driver's utilization of the driving assistance functions, it is necessary to inform the driver of the warning in an appropriate mode.

In order to solve the above problem, an object of the present application is to provide a diving assistance device, a driving assistance method, and a program capable of further preventing abusing/misusing of autonomous driving functions than before. Then, this will ultimately contribute to the development of a sustainable transportation system.

The driving support device according to the present invention adopts the following configurations.
(1) A driving assistance device according to an aspect of the present invention includes: a recognition part that recognizes a surrounding situation of a vehicle; an information terminal that is used by a specific person associated with a driver of the vehicle; and a driving controller that controls one of or both acceleration/deceleration and steering of the vehicle, and the driving controller includes a mode determination part that determines a driving mode in which the vehicle is caused to travel with any of a plurality of kinds of driving assistance imposing different tasks on the driver, a judgment part that determines whether or not the driver is responding to the task, and an execution part that activates a warning in a case where the judgment part determines that the driver is not responding to the task, and transmits information related to a behavior of the driver at a predetermined time before and/or after the warning is activated along with warning information to the information terminal.
(2): In the aspect (1) described above, the judgment part may determine whether or not the behavior of the driver has been corrected after activation of the warning by the execution part.
(3): In the aspect (1) or (2) described above, the driving assistance device may further include a camera that is capable of imaging an interior of the vehicle, and the execution part may image the behavior of the driver before and after the warning is activated with the camera, and transmit information based on the captured image to the information terminal.
(4): In the aspect (1) or (2) described above, the judgment part may acquire information related to the behavior of the driver and evaluate a driving behavior of the driver on the basis of the information, and the execution part may cause an output part of the vehicle to output an evaluation result of the judgment part and/or transmit the evaluation result to a second information terminal used by the driver.
(5): In the aspect (4) described above, the execution part may acquire a result of secondary evaluation, in which the specific person evaluates the behavior of the driver, from the information terminal and cause the output part of the vehicle to output the result of the secondary evaluation and/or transmit the result of the secondary evaluation to the second information terminal.
(6): In the aspect (1) or (2) described above, in a case where a location where the warning has been activated in the past is on a normal route, the execution part may output a cautionary reminder before departure to a destination or near the location where the warning has been activated.
(7): In the aspect (1) or (2) described above, the driving assistance device may further include a storage part that stores road map information, and the execution part may store, in the storage unit, road environment information related to a location where the warning has been activated in a case where the warning has been activated in a first traveled route and output a cautionary reminder at a point similar to the location where the warning has been activated in a case where a road environment of a second route to be traveled next time is similar to the road environment information stored in the storage part.
(8): In the aspect (1) or (2) described above, in a case where the judgment part determines that the driver is not responding to the task, the execution part may execute control to switch a driving mode determined by the mode determination part to a driving mode in which functions are limited and cause the driver to cancel a function limitation by causing a shift lever to be positioned in a non-traveling range or a reverse range.
(9): A driving assistance method according to an aspect of the present invention includes, by a computer: recognizing a surrounding situation of a vehicle; controlling one of or both acceleration/deceleration and steering of the vehicle; determining a driving mode in which the vehicle is caused to travel with any of a plurality of kinds of driving assistance imposing different tasks on a driver; determining whether or not the driver is responding to the task; activating a warning in a case where it is determined that the driver is not responding to the task; and transmitting information related to a behavior of the driver at a predetermined time before and/or after the warning is activated along with warning information to an information terminal used by a specific person associated with the driver.
(10): A program according to an aspect of the present invention causes a computer to: recognize a surrounding situation of a vehicle; control one of or both acceleration/deceleration and steering of the vehicle; determine a driving mode in which the vehicle is caused to travel with any of a plurality of kinds of driving assistance imposing different tasks on a driver; judge whether or not the driver is responding to the task; activate a warning in a case where it is determined that the driver is not responding to the task; and transmit information related to a behavior of the driver at a predetermined time before and/or after the warning is activated along with warning information to an information terminal used by a specific person associated with the driver.

According to the aspects (1) to (10), it is possible to provide a driving assistance device capable of further preventing abusing/misusing of autonomous driving functions than before.

### BRIEF DESCRIPTION OF THE DRAWINGS

FIG. 1 is a system configuration diagram of a vehicle system including a driving assistance device according to an embodiment of the present invention.

FIG. 2 is a block diagram illustrating detailed configurations of a first controller and a second controller in the driving assistance device.

FIG. 3 is a diagram illustrating an example of correspondence of a driving mode, a control state of a host vehicle, and a task.

FIG. 4 is a flowchart illustrating operations of the driving assistance device according to the embodiment of the present invention.

FIG. 5 is a schematic view illustrating operations of the driving assistance device according to the embodiment of the present invention.

### DETAILED DESCRIPTION OF THE INVENTION

Hereinafter, embodiments of a driving assistance device, a driving assistance method, and a program of the present invention will be described with reference to the drawings.

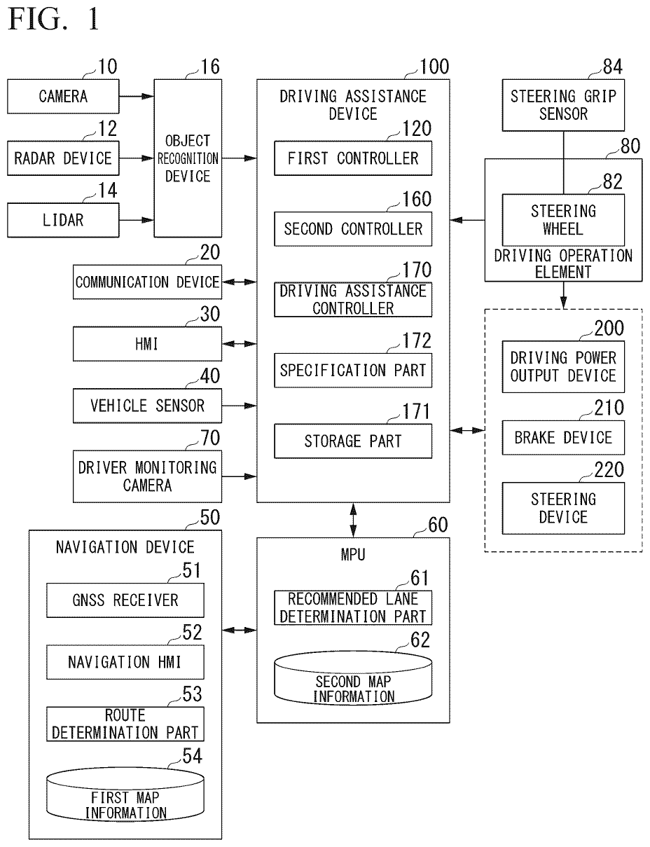

FIG. 1 is a system configuration diagram of a vehicle system including a driving assistance device 100 according to the present embodiment. A vehicle in which the vehicle system is mounted is, for example, a two-wheeled, three-wheeled, or four-wheeled vehicle, and a driving source thereof is an internal combustion engine such as a diesel engine or a gasoline engine, an electric motor, or a combination thereof. The electric motor is operated using electric power generated by a generator connected to the internal combustion engine, or using discharged electric power from a secondary battery or a fuel cell.

The vehicle system includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driver monitor camera 70, a driving operation element 80, a driving assistance device 100, a driving power output device 200, a brake device 210, and a steering device 220.

These devices and equipment are connected to each other by a multiple-communication line, such as a controller area network (CAN) communication lines, a serial communication line, a wireless communication network, or the like. Note that the configuration illustrated in FIG. 1 is merely an example, and some of the configurations may be omitted, or other configurations may be added.

For example, the camera 10 is a digital camera using a solid-state imaging element such as a charge coupled device (CCD) or a complementary metal oxide semiconductor (CMOS). The camera 10 is attached to an arbitrary place on a vehicle in which the vehicle system is mounted. In a case where an image of the front is captured, the camera 10 is attached to a front windshield upper portion, a rearview mirror back surface, or the like. The camera 10 captures images of the surroundings of the vehicle repeatedly and periodically, for example. The camera 10 may also be a stereo camera.

The radar device 12 emits radio waves, such as millimeter waves, around the vehicle and detects the radio waves reflected by objects (reflected waves) to detect at least positions (distances and azimuths) of the objects. The radar device 12 is attached to an arbitrary place of the vehicle. The radar device 12 may detect the positions and the speeds of the objects using a frequency modulated continuous wave (FM-CW) method.

The LIDAR 14 radiates the periphery of the vehicle with light (or electromagnetic waves of a wavelength close to that of light) and measures scattered light. The LIDAR 14 detects the distances to targets on the basis of time from light emission to light reception. The emitted light is, for example, a pulsed laser beam. The LIDAR 14 is attached to an arbitrary position of the vehicle.

The object recognition device 16 performs sensor fusion processing on detection results obtained by some or all of the camera 10, the radar device 12, and the LIDAR 14 to recognize the positions, the types, the speeds, and the like of objects. The object recognition device 16 outputs recognition results to the driving assistance device 100. Note that the object recognition device 16 may output the detection results of the camera 10, the radar device 12, and the LIDAR 14 as they are to the driving assistance device 100. The object recognition device 16 may be omitted from the vehicle system.

The communication device 20 uses, for example, a cellular network, a Wi-Fi network, Bluetooth (registered trademark), or dedicated short range communication (DSRC) to communicate with other vehicles that are present near the vehicle or communicate with various server devices via wireless base stations.

The HMI 30 presents various kinds of information to passengers of the vehicle and receives input operations from the passengers. The HMI 30 includes, for example, various display devices, a speaker, a buzzer, a touch panel, a switch, and keys.

The vehicle sensor 40 includes a vehicle speed sensor that detects a speed of the vehicle, an acceleration sensor that detects acceleration, a yaw rate sensor that detects an angular speed around a vertical axis, an azimuth sensor that detects an orientation of the vehicle, and the like.

The navigation device 50 includes, for example, a global navigation satellite system (GNSS) receiver 51, a navigation HMI 52, and a route determination part 53. The navigation device 50 holds first map information 54 on a storage device such as a hard disk drive (HDD), a flash memory, or the like.

The GNSS receiver 51 specifies the position of the vehicle on the basis of a signal received from a GNSS satellite. The position of the vehicle may be specified or supplemented by an inertial navigation system (INS) using outputs of the vehicle sensor 40.

The navigation HMI 52 includes a display device, a speaker, a touch panel, keys, and the like. A part or an entirety of the navigation HMI 52 may be shared with the HMI 30 described above.

For example, the route determination part 53 determines a route (hereinafter, referred to as a route on a map) from the position of the vehicle specified by the GNSS receiver 51 (or any input position) to a destination input by a passenger using the navigation HMI 52 with reference to the first map information 54.

The first map information 54 is, for example, information that represents road shapes using links that indicate roads and nodes connected by the links. The first map information 54 may include curvatures of the roads, point-of-interest (POI) information, and the like. The route on the map is output to the MPU 60.

The navigation device 50 may perform route guidance using the navigation HMI 52 on the basis of the route on the map. The navigation device 50 may be realized by, for example, a function of a terminal device such as a smartphone, a tablet terminal, or the like, held by a passenger. The navigation device 50 may transmit the current position and a destination to a navigation server via the communication device 20, and acquire the same route as the route on the map from the navigation server.

For example, the MPU 60 includes a recommended lane determination part 61 and holds second map information 62 in a storage device such as an HDD or a flash memory.

The recommended lane determination part 61 divides the route on the map provided from the navigation device 50 into a plurality of blocks (divides the route every 100 [m] in a vehicle traveling direction, for example) and determines a recommended lane for each block with reference to the second map information 62. The recommended lane determination part 61 determines which lane from the left the vehicle is to travel along. The recommended lane determination part 61 determines the recommended lane so that the vehicle can travel along a reasonable route for traveling to a branching destination in a case where there is a branch point on the route on the map.

The second map information 62 is map information that is more accurate than the first map information 54. The second map information 62 includes, for example, lane center information or lane boundary information. In addition, the second map information 62 may include road information, traffic regulation information, address information (addresses and postal codes), facility information, telephone number information, information of prohibition sections where a mode A or a mode B, which will be described later, is inhibited. The second map information 62 may be updated at any time by the communication device 20 communicating with an external device.

The driver monitor camera 70 is, for example, a digital camera that uses a solid-state imaging element such as a CCD or a CMOS. The driver monitor camera 70 is attached to an arbitrary place in the vehicle at a position and with an orientation at which it is possible to image the upper torso of a passenger seated on a driver's seat of the vehicle (hereinafter, a driver) from the front (in the orientation in which the face is imaged). For example, the driver monitor camera 70 is attached to an upper part of a display device installed at the center of an instrument panel of the vehicle.

The driving operation element 80 includes, for example, an accelerator pedal, a brake pedal, a shift lever, and other operation elements in addition to a steering wheel 82. The driving operation element 80 includes a sensor attached thereto to detect the amount of operation or whether or not operations have been performed, and a detection result thereof is output to the driving assistance device 100 or some or all of the driving power output device 200, the brake device 210, and the steering device 220.

The operation element does not necessarily have an annular shape and may be in the form of an unusual steering wheel, a joystick, a button, or the like. A steering grip sensor 84 is attached to the steering wheel 82.

The steering grip sensor 84 is realized by a capacitance sensor or the like, and outputs a signal capable of detecting whether or not the driver is gripping the steering wheel 82 (this means that the driver is in contact with the steering wheel 8 in a state where the driver can apply power thereto) to the driving assistance device 100.

The driving assistance device 100 includes, for example, a first controller 120, a second controller 160, a driving assistance controller 170, a storage part 171, and a specification part 172. Each of the first controller 120 and the second controller 160 is realized by a hardware processor such as a central processing unit (CPU) executing a program (software).

In addition, some or all of these components may be realized by hardware (circuit part; including circuitry) such as large scale integration (LSI), an application specific integrated circuit (ASIC), a field-programmable gate array (FPGA), a graphics processing unit (GPU), a system on chip (SOC), or the like, or may be realized through cooperation of software and hardware.

The program may be stored in a storage device such as an HDD, a flash memory, or the like, (a storage device including a non-transient storage medium) of the driving assistance device 100 in advance, or may be stored in a detachable storage medium such as a DVD, a CD-ROM, or the like and may be installed in the HDD or the flash memory of the driving assistance device 100 by the storage medium (non-transient storage medium) being attached to a drive device.

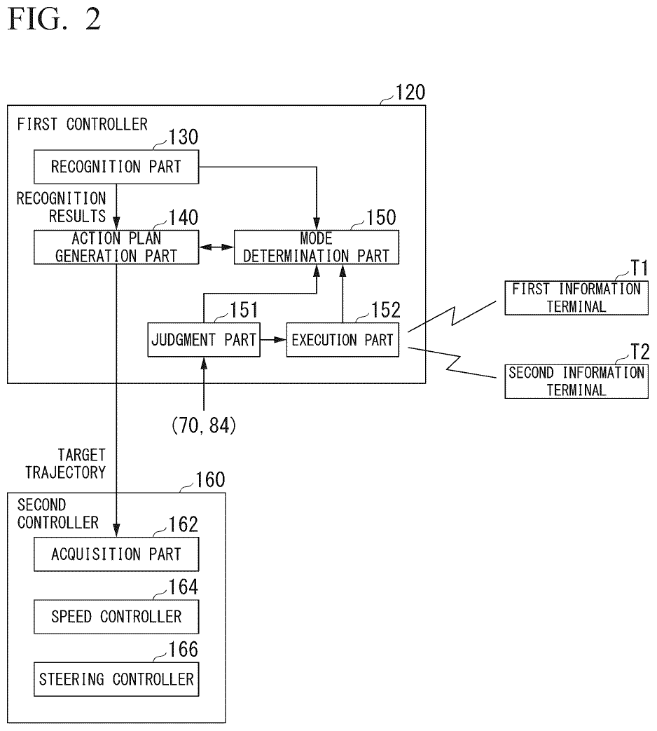

The first controller 120 includes, for example, a recognition part 130, an action plan generation part 140, a mode determination part 150, a judgment part 151, and an execution part 152 as illustrated in FIG. 2. The first controller 120 performs functions based on artificial intelligence (AI) and functions based on a pre-defined model, for example, in parallel.

For example, a function of “recognizing an intersection” may be realized by performing recognition of the intersection using deep learning or the like and recognition based on pre-defined conditions (such as a traffic light, a road sign, or the like that can be pattern-matched) in parallel and scoring and comprehensively evaluating both kinds of recognition. Accordingly, reliability of autonomous driving is guaranteed.

The recognition part 130 recognizes a surrounding situation of the vehicle on the basis of information input from the camera 10, the radar device 12, and the LIDAR 14 via the object recognition device 16. The recognition part 130 recognizes states of each object, such as a position, a speed, an acceleration, and the like thereof in the surroundings of the vehicle.

The position of the object is recognized, for example, as a position on an absolute coordinate system including a representative point (a center of gravity, a drive shaft center, or the like) of the vehicle as an origin and is used for control. The position of the object may be represented by a representative point such as the center of gravity, a corner, or the like of the object, or may be represented by a region. The “states” of the object may include an acceleration and a jerk of the object, or “a behavioral state” (for example, whether the object is changing a lane or is attempting to change a lane).

In addition, the recognition part 130 recognizes, for example, the lane in which the vehicle is traveling (traveling lane), lane marker lines, and the like.

The recognition part 130 recognizes the position and the posture of the vehicle relative to the traveling lane when recognizing the traveling lane. The recognition part 130 may recognize, for example, a deviation of a reference point of the vehicle from the lane center and an angle of the traveling direction of the vehicle with respect to a line obtained by connecting the center of the lane as the relative position and the posture of the vehicle relative to the traveling lane. On the other hand, the recognition part 130 may recognize the position of a reference point of the vehicle relative to any side end portion of the traveling lane (a road division line or a road boundary) as the relative position of the vehicle relative to the traveling lane.

The action plan generation part 140 generates a target trajectory for the vehicle to automatically (without driver's operations) travel in the future such that the vehicle travels along the recommended lane determined by the recommended lane determination part 61 in principle and further avoids approach to objects (except for the road division lines, the road markings, manholes, and the like over which the vehicle can travel) recognized by the recognition part 130.

For example, the recognition part 130 sets a risk region around an object, the states of which have been output, and the recognition part 130 sets a risk as an index value indicating a degree to which the vehicle should not approach it in the risk region.

The action plan generation part 140 generates a target trajectory so that the vehicle does not pass a point where the risk is equal to or greater than predetermined value and travels within a recognized traveling lane. Since some object may move, not one risk distribution is set for each control cycle, and risk distributions are set for a plurality of timings in the future in consideration of the future positions of the object predicted on the basis of the speed of the object.

For example, the target trajectory is expressed as sequentially aligned points (trajectory points) that the vehicle is to reach. Each trajectory point is a point to be reached by the vehicle for each predetermined traveling distance (for example, several [m]) along the road, and apart from this, a target speed and a target acceleration for each predetermined sampling time (for example, several tenths of a second) are generated as parts of the target trajectory. In addition, the trajectory point may be the position that the vehicle should reach at a sampling clock time for each predetermined sampling time. In this case, information regarding the target speed and the target acceleration is expressed as an interval between trajectory points.

The action plan generation part 140 may set autonomous driving events when generating the target trajectory. The autonomous driving events include a fixed speed traveling event, a low speed following traveling event, a lane change event, a branching event, a merging event, and a takeover event, and the like. The action plan generation part 140 generates a target trajectory according to triggered events.

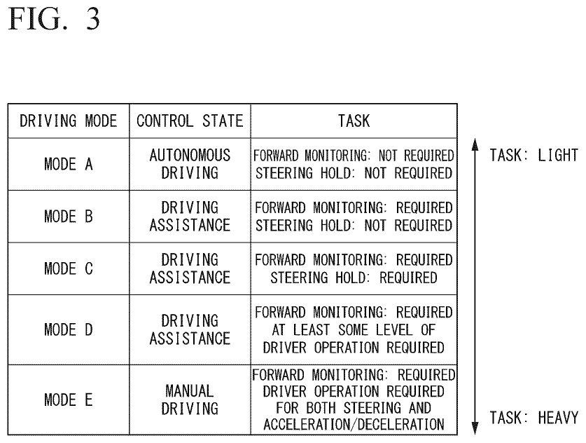

The mode determination part 150 determines a driving mode in which the vehicle is caused to travel with any of a plurality of kinds of driving assistance imposing different tasks on the driver of the vehicle. The tasks include, for example, forward monitoring of the driver, gripping of the steering wheel 82, and the like. FIG. 3 is a diagram illustrating an example of a correspondence of a driving mode, a vehicle control state, and a task. There are five modes of the vehicle, for example, a mode A to a mode E. The control state, that is, the degree of automation of the vehicle driving control is the highest in the mode A, becomes lower in the order of the mode B, the mode C, and the mode D, and is the lowest in the mode E.

On the contrary, the tasks imposed on the driver is the lightest in the mode A, becomes heavier in the order of the mode B, the mode C, and the mode D and is the heaviest in the mode E. Note that since control states that do not correspond to the autonomous driving are achieved in the modes D and E, the driving assistance device 100 is in charge of ending the control related to the autonomous driving and transitioning to driving assistance or manual driving. Hereinafter, the content of each driving mode will be described as an example.

In the mode A, the vehicle enters an autonomous driving state, and the driver is no longer required to monitor the area ahead or grip the steering wheel 82 (steering grip in the drawing). However, even in the mode A, the driver is required to be ready to quickly switch to manual driving in response to a request from the system centered on the driving assistance device 100. Note that the mode A and the autonomous driving may be included in the driving assistance. In other words, the driving assistance may include the autonomous driving and driving assistance in the mode B and the following modes.

Note that the autonomous driving described herein means that both steering and acceleration/deceleration are controlled independently of operations of the driver. The term “ahead” means the space in the vehicle traveling direction visually recognized via the front windshield. The mode A is, for example, a driving mode that can be executed in a case where conditions that the vehicle is traveling at a predetermined speed (about 50 [km/h], for example) or less on a car road such as a highway and that there is a tracking target preceding vehicle, for example, are satisfied and may be referred to as traffic jam pilot (TJP). In a case where these conditions are no longer satisfied, the mode determination part 150 changes the driving mode of the vehicle to the mode B.

In the mode B, the vehicle enters a driving assistance state, and the driver is assigned the task of monitoring the area ahead of the vehicle (hereafter referred to as “forward monitoring”), while the driver is not assigned the task of gripping the steering wheel 82. In the mode C, the vehicle enters the driving assistance state, and the driver is assigned the tasks of forward monitoring and gripping the steering wheel 82. The mode D is a driving mode that requires driving operations by the driver to some extent for at least either the steering or the acceleration/deceleration of the vehicle.

In the mode D, driving assistance such as adaptive cruise control (ACC) or a lane keeping assist system (LKAS), for example, is performed. In the mode E, a manual driving state requiring driving operations by the driver for both the steering and the acceleration/deceleration is brought about. It is a matter of course that in both the modes D and E, the driver is assigned the tasks of monitoring the area ahead of the vehicle.

Here, the driving mode in the present embodiment is not limited to that exemplified in FIG. 3 and may be defined by other definitions. For example, there may be driving modes having loose and severe threshold values for determining that the steering wheel is being gripped among the driving modes requiring both the forward monitoring and the gripping of the steering wheel. Also, driving assistance based on a lane keeping assistance system (LKAS), adaptive cruise control (ACC), auto lane changing (ALC) road departure mitigation (RDM), and a collision mitigation braking system (CMBS) may also be adopted as driving modes.

More specifically, it is only necessary for either the driver's left or right hand to be in contact with the steering wheel 82 in a certain driving mode, but a driving mode that imposes a heavier task on the driver than that may be defined so that the driver needs to grip the steering wheel 82 with both hands with a force equal to or greater than a threshold value as another driving mode. In addition, driving modes in which the severity of the tasks imposed on the driver is different may be defined in any way.

The driving assistance device 100 executes auto lane changing (ALC) in accordance with a driving mode. There are an automatic lane change (1) requested by the system and an automatic lane change (2) requested by the driver.

Examples of the automatic lane change (1) include an automatic lane change for overtaking, which is performed when the speed of the preceding vehicle is lower than the speed of the host vehicle by a reference speed or more, and an automatic lane change for proceeding toward the destination (an automatic lane change due to a change in a recommended lane).

The automatic lane change (2) is performed to cause the vehicle to change the lane toward an operation direction in a case where a direction indicator is operated by the driver when conditions related to the speed and the positional relationship with the surrounding vehicles are satisfied.

In the mode A, the driving assistance device 100 does not perform both the automatic lane changes (1) and (2), for example. In the modes B and C, the driving assistance device 100 performs both the automatic lane changes (1) and (2), for example. In the mode D, the driving assistance device 100 does not perform the automatic lane change (1) but performs the automatic lane change (2), for example. In the mode E, neither the automatic lane changes (1) nor (2) are performed, for example.

The mode determination part 150 determines a driving mode in which the vehicle is caused to travel with any of a plurality of kinds of driving assistance imposing different tasks on the driver of the vehicle. In a case where the driver does not execute a task related to the determined driving mode (hereinafter, the current driving mode), the mode determination part 150 may change the driving mode of the vehicle to a driving mode imposing a heavier task.

In a case where the driver is in a posture in which the driver cannot switch to manual driving in response to a request from the system in mode A (in a case where the driver continues to look outside a permitted area or in a case where a sign of driving difficulty is detected, for example), for example, the mode determination part 150 may use the HMI 30 to prompt the driver to switch to the manual driving, and if the driver does not respond, the mode determination part 150 may perform control to cause the vehicle to approach the road shoulder and gradually stop, and to stop the autonomous driving. After the autonomous driving is stopped, the host vehicle enters the state of the mode D or E, and the driver can start the vehicle by a manual operation. Hereinafter, the same applies to “stop the autonomous driving.”

In a case where the driver is not monitoring the area ahead in the mode B, the mode determination part 150 may use the HMI 30 to prompt the driver to monitor the area ahead, and if the driver does not respond, the mode determination part 150 may perform control to cause the vehicle to approach the road shoulder and gradually stop and to stop the autonomous driving. In a case where the driver is not monitoring the area ahead or is not gripping the steering wheel 82 in the mode C, the mode determination part 150 may use the HMI 30 to prompt the driver to monitor the area ahead and/or grip the steering wheel 82, and if the driver does not respond, the mode determination part 150 may perform control to cause the vehicle to approach the road shoulder and gradually stop and to stop the autonomous driving.

ACC (acceleration/deceleration control) is control in which the vehicle automatically controls the speed of the vehicle to follow a preceding vehicle while keeping a constant distance between the vehicle itself and the preceding vehicle. In a case where there is no preceding vehicle, the speed of the vehicle is controlled so that the vehicle travels at a preset speed.

LKAS (lane keeping control) controls the steering device 220 so that the vehicle M does not deviate from the traveling lane. For example, the driving assistance controller 170 controls the steering device 220 so that the vehicle travels at the center or near the center of the traveling lane. Hereinafter, this control may be referred to as “lane keeping control”. The driving assistance controller 170 executes hands-on lane keeping control and hands-off lane keeping control.

The hands-on lane keeping control is control that is executed in a state where the driver is gripping the steering wheel 82 (a state where the steering grip sensor 84 is detecting the gripping of the steering wheel 82). Conditions under which the hands-on lane keeping control is executable are less stringent than those under which the hands-off lane keeping control is executable. For example, the hands-on lane keeping control is executed under conditions that the speed of the vehicle is equal to or greater than a predetermined speed and the driver is monitoring the area ahead.

The hands-off lane keeping control is control that is executed in a state where the driver is not gripping the steering wheel 82 (a state where the steering grip sensor 84 is not detecting the gripping of the steering wheel 82). The hands-off lane keeping control is executable in a case where the following conditions are satisfied, for example. The speed of the vehicle is equal to or greater than a predetermined speed, the vehicle is traveling on a predetermined road (for example, a preset road or road type in which the hands-off lane keeping control is executable), and the driver is monitoring the area ahead. The hands-off lane keeping control is executed in a case where the driver is monitoring the area ahead, and the hands-off lane keeping control is not executed or stopped in a case where the driver is not monitoring the area ahead.

The above-described conditions under which the hands-on lane keeping control and the hands-off lane keeping control are executable are examples, other conditions (for example, a condition that the vehicle is tracking a preceding vehicle) may be included, or some conditions may be omitted. It is only necessary for the conditions under which the hands-on lane keeping control is executable to be less stringent than the conditions under which the hands-off lane keeping control is executable (or it is only necessary for the conditions under which the hands-off lane keeping control is executable to be more stringent than the conditions under which the hands-on lane keeping is executable).

RDM is control that provides warning control to the driver, reaction force control that provides a reaction force to a driver's operation of the steering wheel 82 in a direction which would deviate from the traveling lane, or steering control so that the vehicle moves in a direction toward the center of the traveling lane, in a case where the vehicle deviates from the traveling lane.

CMBS is control that warns and alerts the driver through display, warning, or the like in a case where there is a concern that the vehicle may collide against a surrounding obstacle (another vehicle or a passenger) and executes at least either steering control or acceleration/deceleration control to assist collision avoidance and damage reduction in a case where the vehicle further approaches the obstacle.

The judgment part 151 determines whether the driver is responding to a task imposed by the current driving mode on the basis of an image from the driver monitor camera 70 and a detection result of the steering grip sensor 84. In other words, the judgment part 151 acquires information related to a driver's behavior on the basis of the image from the driver monitor camera 70 and the detection result of the steering grip sensor 84 and evaluates the driving behavior of the driver on the basis of the information.

Furthermore, the judgment part 151 determines whether the driver's behavior has been corrected after the activation of the warning by the execution part 152. Such a judgment result of the judgment part 151 is provided to the execution part 152 and is used for switching the driving mode by the mode determination part 150 and external transmission of various kinds of information.

For example, the judgment part 151 analyzes the image captured by the driver monitor camera 70 to perform posture estimation processing, and determines whether the driver is in a posture in which the driver cannot move to the manual driving in response to a request from the system. In addition, the judgment part 151 analyzes the image captured by the driver monitor camera 70 to perform gaze estimation processing and determines whether or not the driver is monitoring the area ahead. The judgment part 151 determines whether or not the driver is gripping the steering wheel 82 on the basis of a detection result of the steering grip sensor 84.

The execution part 152 activates a warning in a case where the judgment part 151 determines that the driver is not responding to the task imposed in the current driving mode. Also, in a case where the above-described judgment part 151 determines that the driver is not responding to the task, the execution part 152 transmits information related to behaviors of the driver at a predetermined time before/and after the warning is activated along with warning information to an external communication terminal.

The external communication terminal mentioned above is a first information terminal T1 used by a specific person associated with the driver of the vehicle. The first information terminal T1 is an information terminal that can wirelessly communicate information related to the driver's behavior with the execution part 152 using a predetermined communication protocol, and is for example, a smartphone. The execution part 152 acquires a result of secondary evaluation in which the specific person evaluates the driver's behavior.

In addition to such a first information terminal T1, the execution part 152 also performs wireless communication with a second information terminal T2. The second information terminal T2 is an information terminal used by the driver of the vehicle and is, for example, a smartphone. The execution part 152 causes the output part (HMI 30) of the vehicle to output and/or transmit, to the second information terminal T2, the evaluation result of the judgment part 151 and/or the result of the secondary evaluation performed by the specific person.

In a case where the location where the warning has been activated in the past is on a normal route of the traveling of the vehicle, the execution part 152 outputs a cautionary reminder before departure to the destination or near the location where the warning has been activated. Furthermore, in a case where the warning has been activated on a first route on which the vehicle has traveled, the execution part 152 stores road environment information related to the location in the storage part 171 and outputs a cautionary reminder at the same point as that where the warning has been activated in a case where a road environment of a second route on which the vehicle travels next is similar to the road environment information stored in the storage part 171.

Furthermore, the execution part 152 executes control to switch the current driving mode determined by the mode determination part 150 to a driving mode in which functions are limited, on the basis of whether or not the driver's behavior has been changed after the activation of the warning and a traveling situation in the surroundings of the vehicle recognized by the recognition part 130.

The second controller 160 controls the driving power output device 200, the brake device 210, and the steering device 220 such that the vehicle passes the target trajectory generated by the action plan generation part 140 on schedule.

The second controller 160 includes, for example, an acquisition part 162, a speed controller 164, and a steering controller 166 as illustrated in FIG. 2. The acquisition part 162 acquires information regarding the target trajectory (trajectory point) generated by the action plan generation part 140 and causes the memory (not illustrated) to store it. The speed controller 164 controls the driving power output device 200 or the brake device 210 on the basis of a speed element accompanying the target trajectory stored in the memory. The steering controller 166 controls the steering device 220 in accordance with how the target trajectory stored in the memory is curved. The processing of the speed controller 164 and the steering controller 166 is realized, for example, by a combination of feed-forward control and feedback control. As an example, the steering controller 166 performs a combination of feed-forward control based on the curvature of the road in front of the vehicle and feedback control based on deviation from the target trajectory.

The driving assistance controller 170 controls one of or both acceleration/deceleration and steering of the vehicle by controlling the driving power output device 200, the brake device 210, and the steering device 220 in a case where the vehicle driving assistance is to be performed, that is, in a case where the mode determination part 150 determines the mode B or either the mode B or the mode C as a driving mode.

The storage part 171 stores information related to the driver's behavior when the warning is activated. The information related to the driver's behavior stored in the storage part 171 is, for example, information related to an operation that the driver has performed on the vehicle. The storage part 171 provides the information related to the driver's behavior to the specification part 172 in response to a reading request input from the specification part 172. The information related to the behavior may be an image, a movie, a text indicating content of the behavior (the steering wheel 82 is not being gripped, the driver is not monitoring the area ahead, or the like), an illustration indicating content of the behavior, or the like.

The storage part 171 stores road map information related to roads that the vehicle will pass through in advance. Furthermore, the storage part 171 sequentially stores road environment information provided from the execution part 152 and provides road environment information previously stored in response to a reading request input from the execution part 152 to the execution part 152.

The specification part 172 specifies a safe driving assistance function triggered the warning activation on the basis of the information related to the driver's behavior acquired from the storage part 171. In other words, the specification part 172 specifies which of a plurality of safe driving assistance functions constituting the vehicle system the cause of the above-described warning activated by the execution part 152 is.

The above-described execution part 152 imposes a limit to the function specified by the specification part 172. The function limitation executed by the execution part 152 is for causing a control timing or a control amount of at least one safety driving assistance function to be different from an ordinary control timing or control amount. Also, the function limitation executed by the execution part 152 is for releasing the function limitation by positioning a shift lever in a non-traveling range or a reverse range.

The driving power output device 200 outputs a driving power (torque) for the vehicle to travel to driving wheels. The driving power output device 200 includes a combination of, for example, an internal combustion engine, an electric motor, and a gearbox, as well as an electronic control unit (ECU) that controls these. The ECU controls the above configurations according to information input from the second controller 160 or information input from the driving operation element 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor according to the information input from the second controller 160 or the information input from the driving operation element 80 so that a brake torque corresponding to a braking operation is output to each wheel.

The brake device 210 may include a backup mechanism that transmits the hydraulic pressure generated by operating a brake pedal included in the driving operation element 80 to the cylinder via a master cylinder. Note that the brake device 210 is not limited to the configuration described above and may be an electronically controlled hydraulic brake device that controls an actuator according to information input from the second controller 160 and transmits the hydraulic pressure of the master cylinder to the cylinder.

The steering device 220 includes, for example, a steering ECU and an electric motor. The electric motor causes a force to act on a rack and pinion mechanism, for example, to change the direction of steered wheels. The steering ECU drives the electric motor and changes the direction of the steered wheels according to the information input from the second controller 160 or the information input from the driving operation element 80.

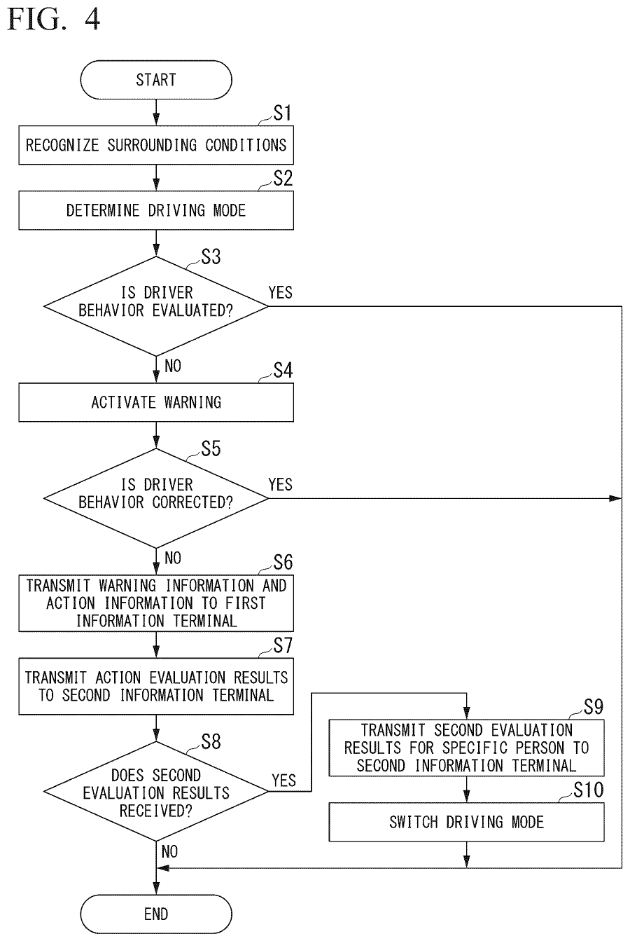

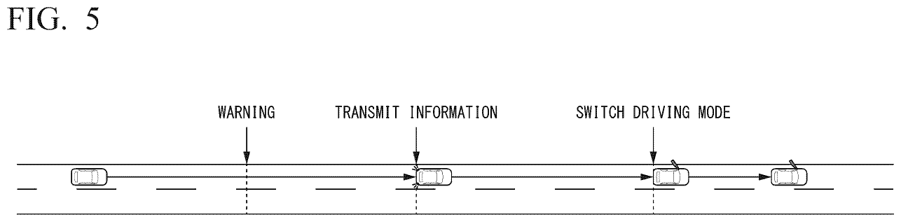

Subsequently, operations of the driving assistance device 100, a driving assistance method, and a program according to the present embodiment will be described with reference to the flowchart in FIG. 4 and the schematic diagram in FIG. 5.

Once the driving assistance device 100 starts the driving assistance, then the recognition part 130 of the first controller 120 recognizes the surrounding situation of the vehicle on the basis of information input from the camera 10, the radar device 12, and the LIDAR 14 via the object recognition device 16 (Step S1).

The mode determination part 150 of the first controller 120 determines one driving mode from among the plurality of driving modes (the modes A to E) in which vehicle driving states and tasks are associated as illustrated in FIG. 3 (Step S2). In a case where a control state is driving assistance, for example, the mode determination part 150 determines any of the mode B, the mode C, and the mode D as a driving mode. Step S2 may be executed before Step S1.

In a case where the driving mode is the mode B, the mode C, or the mode D, the driving assistance controller 170 causes the vehicle to travel with driving assistance by controlling the driving power output device 200, the brake device 210, and the steering device 220. If the driving mode is set to the mode B, the mode C, or the mode D during traveling of the vehicle, for example, then the driving assistance controller 170 starts the driving assistance control.

The judgment part 151 of the first controller 120 determines whether or not the driver is responding to a task imposed in the current driving mode (Step S3). In other words, the judgment part 151 determines whether or not the driver's behavior is responding to the task imposed in the current driving mode (performs driver's behavior evaluation) on the basis of an image from the driver monitor camera 70 and a detection result of the steering grip sensor 84.

The execution part 152 of the first controller 120 activates a warning in a case where the judgment part 151 determines that the driver is not responding to the task imposed in the current driving mode (Step S4). In other words, the execution part 152 activates the warning during traveling of the vehicle as illustrated in FIG. 5. Then, the judgment part 151 determines whether or not the driver's behavior has been corrected to respond to the task after the activation of the warning by the execution part 152 (Step S5).

In a case where the judgment part 151 determines that the driver's behavior has not been corrected, the execution part 152 transmits warning information indicating content of the warning and behavior information (an image or a movie, for example) indicating the driver's behavior to the first information terminal T1 used by the specific person (Step S6). In other words, the execution part 152 transmits the warning information and the behavior information to the first information terminal T1 during the traveling of the vehicle as illustrated in FIG. 5. Then, the execution part 152 transmits a result of evaluating the driver's behavior (behavior evaluation result) obtained by the judgment part 151 to the second information terminal T2 used by the driver (Step S7).

Here, the behavior evaluation result of the judgment part 151 is a primary evaluation result for the behavior of the driver who is driving the vehicle with driving assistance. The specific person evaluates the behavior of the driver who is driving the vehicle with the driving assistance by checking the warning information and the behavior information received by the first information terminal T1. The evaluation result of the specific person is a secondary evaluation result for the driver's behavior. The specific person causes the first information terminal T1 to transmit the secondary evaluation result to the execution part 152.

Once the secondary evaluation result of the specific person is received from the first information terminal T1 (Step S8), then the execution part 152 transmits the secondary evaluation result of the specific person to the second information terminal T2 (Step S9). In other words, the driver who is the user of the second information terminal T2 recognizes the behavior of the driver himself/herself by checking the secondary evaluation result of the specific person using the second information terminal T2.

Furthermore, the execution part 152 causes the mode determination part 150 to execute switching of the driving mode on the basis of whether or not the driver's behavior has been changed after the activation of the warning as judged by the judgment part 151 and the traveling situation in the surroundings of the vehicle recognized by the recognition part 130 of the first controller 120 (Step S10). In other words, the execution part 152 causes the driving mode to be switched during the traveling of the vehicle as illustrated in FIG. 5.

The mode determination part 150 switches the control mode that has already been determined to a driving mode in which the functions are further limited, on the basis of a control instruction input from the execution part 152. The mode C is a driving mode in which the functions are further limited as compared with the mode B, among the mode B, the mode C, and the mode D in which the control states are driving assistance. Also, the mode D is a driving mode in which the functions are further limited as compared with the mode C.

In a case where the judgment part 151 determines that the driver is not responding to the task imposed in the mode B during the driving assistance in the mode B, for example, the execution part 152 outputs a control instruction to switch the mode B (current mode) that has already been determined to the mode C to the mode determination part 150.

In a case where the judgment part 151 determines that the driver is not responding to the task imposed in the mode C during the driving assistance in the mode C, the execution part 152 outputs a control instruction to switch the mode C (current mode) that has already been determined to the mode D to the mode determination part 150.

In the mode A, in a case where the judgment part 151 determines that the driver is not responding to the task imposed in the mode A, for example, the execution part 152 may output a control instruction to switch the mode A (current driving mode) that has already been determined to the mode B to the mode determination part 150. As a result, the mode determination part 150 switches the mode A (current driving mode) to the mode B. The task in Mode A is that the driver is in a posture in which the driver cannot move on to the manual driving in response to a request from the system (for example, the driver continuously looking outside the allowable area, a sign of a difficulty in driving, or the like is detected in an image from the driver monitor camera 70).

Furthermore, the execution part 152 causes the driver to cancel the above-described function limitation if the driver positions the shift lever in the non-traveling range or the reverse range. In other words, the function limitation in the driving assistance is continued until the traveling vehicle is stopped.

As described above, the driving assistance device 100 according to the present embodiment includes: the recognition part 130 that recognizes a surrounding situation of the vehicle; the first information terminal T1 (information terminal) that is used by the specific person associated with the driver of the vehicle; and the driving assistance controller 170 that controls one of or both the acceleration/deceleration and the steering of the vehicle, and the driving assistance controller 170 includes the mode determination part 150 that determines the driving mode in which the vehicle is caused to travel with any of the plurality of kinds of driving assistance imposing different tasks on the driver, the judgment part 151 that determines whether or not the driver is responding to the task, and the execution part 152 that activates the warning in a case where the judgment part 151 determines that the driver is not responding to the task, and transmits the information related to the behavior of the driver at the predetermined time before and/or after the warning is activated along with the warning information to the first information terminal T1 (information terminal).

In other words, according to the present embodiment, the behavior information of the driver before and after the warning is activated is shared by a person in a close relationship with the driver, such as a family member, a friend, a coworker, an administrator, or the like, along with the content of the warning activated in response to abusing or misusing of the driving assistance device, and it is thus possible to expect an effect of further improvement by preventing misusing of the safe driving assistance device by involving not only the driver but also the surrounding people.

More precisely, according to the present embodiment, it is possible to obtain a feedback to prompt the driver to make an improvement from the specific person who shares the information, and an advice from a person in a close relationship is more likely to be accepted as compared with a simple warning, which motivates the driver to recognize how to correctly use the autonomous driving (AD)/advanced driving assistance system (ADAS) again. Therefore, according to the present embodiment, it is possible to provide the driving assistance device 100 capable of further preventing abusing/misusing of the autonomous driving functions than before.

In the driving assistance device 100 according to the present embodiment, the judgment part 151 determines whether or not the driver's behavior has been corrected after the activation of the warning by the execution part 152. According to such a present embodiment, the change in driver's behavior after issuance of the cautionary reminder through the warning is determined, and it is thus possible to provide a more appropriate reminder. Note that the above-described determination also includes determination regarding whether or not there has been a change in behavior after reception of a feedback from the specific person who monitors a change in behavior before and after the activation of the warning with measurement equipment such as a driver monitor camera, a steering grip sensor, or a load sensor.

The driving assistance device 100 according to the present embodiment further includes the driver monitor camera 70 (camera) that is capable of imaging the interior of the vehicle, and the execution part 152 images the driver's behavior before and after the warning is activated with the driver monitor camera 70 (camera) and transmits information based on the captured video to the first information terminal T1 (information terminal).

According to such a present embodiment, the driver's behavior at the time of misusing can be shared along with the warning information based on the misusing by the specific person in real time, and the feedback from the specific person thus becomes more appropriate. Although the video itself may be used to show how the driver in the vehicle looks like, any content information that enables the situation to be recognized, such as a stationary image, a simple animation, or an illustration, may be used. In a case where information that is different from the moving image is used, a secondary effect that a communication load can be reduced as compared with the moving image is also obtained.

In the driving assistance device 100 according to the present embodiment, the judgment part 151 acquires the information related to the driver's behavior and evaluates the driver's driving behavior on the basis of the information, and the execution part 152 causes the output part (HMI 30) of the vehicle to output and/or transmit, to the second information terminal T2 used by the driver, the evaluation result of the judgment part 151. According to such a present embodiment, the result of misusing is provided to the vehicle or the second information terminal T2 owned by the driver after the driving ends, and it is thus possible to provide an opportunity to look back the behavior of the driver himself/herself. The evaluation is evaluation of statistically processing a degree (the number of times, a period of time, and the like) to which the driver has not responded to the task. The evaluation is scoring, ranking, binary evaluation such as pass/fail, and the like.

In the driving assistance device 100 according to the present embodiment, the execution part 152 causes the output part (HMI 30) of the vehicle to output the result of the secondary evaluation in which the specific person evaluates the driver's behavior and/or acquires the result from the first information terminal T1 (information terminal) and transmits the result of the secondary evaluation to the second information terminal T2. According to such a present embodiment, the specific person can optionally perform the secondary evaluation by checking the driver's behavior transmitted from the vehicle, and providing the result of the secondary evaluation performed by the specific person motivates the driver to recognize how to correctly use the autonomous driving (Ad)/advanced driving assistance system (ADAS) because the driver is more likely to accept advice from the person in a close relationship. Note that an incentive may be given to the specific person who performs the secondary evaluation.

In the driving assistance device 100 according to the present embodiment, in a case where a location where the warning has been activated in the past is on a normal route, the execution part 152 outputs a cautionary reminder before departure to a destination and near the location where the warning has been activated. According to such a present embodiment, an effect of making the driver pay further attention by issuing the cautionary reminder such as a guidance before the next departure and near the location where misusing has occurred in a case where the misusing has occurred in the ordinary route (a route through which the vehicle has passed a predetermined number of times or more, for example) for commutation or for going to school is obtained.

The driving assistance device 100 according to the present embodiment further includes the storage part that stores the road map information, and the execution part 152 stores, in the storage part 171, the road environment information related to the location where the warning has been activated in a case where the warning has been activated in the first traveled route, and outputs a cautionary reminder at a point similar to the location where the warning has been activated in a case where the road environment of the second route traveled next time is similar to the road environment information stored in the storage part 171. “Similar to the road environment information” means that the type of the road is the same (highway), the degree of congestion of the road is equal to or less than a predetermined degree, or a straight line of the road continues by a predetermined distance.

According to such a present embodiment, in a case where misusing has occurred in a route traveled in the past and elements similar to those of the location, it is possible to make the driver to pay further attention by outputting a cautionary reminder such as a guidance near a location where a similar element is determined even in a case where the element similar to the location, the terrain, the road shape, or the like is present in a section for traveling another route.

In the driving assistance device 100 according to the present embodiment, the execution part 152 executes the control to switch the driving mode determined by the mode determination part 150 to a driving mode in which functions are limited in a case where the judgment part 151 determines that the driver is not responding to the task imposed in the current driving mode, and causes the driver to cancel the function limitation by causing the driver to position the shift lever to position in the non-traveling range or the reverse range. According to such a present embodiment, there is an effect of psychologically preventing abusing/misusing of the safe driving assistance function by causing the complicated operation to intervene for canceling the function limitation.

More specifically, the function limitation may be able to be automatically canceled by the system (controller) recognizing that the driver has been changed to another driver or the driving has temporarily been stopped in the case where the driver has operated the shift position to the P range, and may be able to be automatically canceled by causing the driver to perform, for a predetermined period of time, a shift operation for the shift position from the D range to the R range or the N range in which the driving output form of the traveling power output device is significantly switched.

The driving assistance method according to the present embodiment includes: recognizing the surrounding situation of the vehicle; controlling one of or both the acceleration/deceleration and the steering of the vehicle; determining a driving mode in which the vehicle is to travel with any of the plurality of kinds of driving assistance imposing different tasks on the driver; determining whether or not the driver is responding to the task; activating the warning in a case where it is determined that the driver is not responding to the task; and transmitting the information related to the driver's behavior at the predetermined time before and/after the activation of the warning along with the warning information to the information terminal used by the specific person associated with the driver. According to such a present embodiment, it is possible to provide a driving assistance method capable of further preventing abusing/misusing of the autonomous driving functions than before.

The program according to the present embodiment causes a computer to: recognize the surrounding situation of the vehicle; control one of or both the acceleration/deceleration and the steering of the vehicle; determine the driving mode in which the vehicle is caused to travel with any of the plurality of kinds of driving assistance imposing different tasks on the driver; determine whether or not the driver is responding to the task; activate the warning in a case where it is determined that the driver is not responding to the task; and transmit the information related to the driver's behavior at the predetermined time before and/or after the activation of the warning along with the warning information to the information terminal used by the specific person associated with the driver. According to such a present embodiment, it is possible to provide a program capable of further preventing abusing/misusing of the autonomous driving functions than before.

Although the embodiments of the present invention have been described above, the invention is not limited to the above embodiments. Various variations and substitutions can be made without departing from the gist of the present invention. For example, the device configuration illustrated in FIGS. 1 and 2 are just examples of the present invention, and various modifications can be conceivable.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

100 Driving assistance device
120 First controller
130 Recognition part
150 Mode determination part
151 Judgment part
152 Execution part
160 Second controller
170 Driving assistance controller
171 Storage part
172 Specification part
T1 First information terminal
T2 Second information terminal

What is claimed is:

1. A driving assistance device comprising:
a recognition part that recognizes a surrounding situation of a vehicle;
an information terminal that is used by a specific person associated with a driver of the vehicle; and
a driving controller that controls one of or both acceleration/deceleration and steering of the vehicle,
wherein the driving controller includes
a mode determination part that determines a driving mode in which the vehicle is caused to travel with any of a plurality of kinds of driving assistance imposing different tasks on the driver,
a judgment part that determines whether or not the driver is responding to the task, and
an execution part that activates a warning in a case where the judgment part determines that the driver is not responding to the task, and transmits information related to a behavior of the driver at a predetermined time before and/or after the warning is activated along with warning information to the information terminal.

2. The driving assistance device according to claim 1, wherein the judgment part determines whether or not the behavior of the driver has been corrected after activation of the warning by the execution part.

3. The driving assistance device according to claim 1, further comprising:
a camera that is capable of imaging an interior of the vehicle,
wherein the execution part images the behavior of the driver before and after the warning is activated with the camera, and transmits information based on the captured image to the information terminal.

4. The driving assistance device according to claim 1,
wherein the judgment part acquires information related to the behavior of the driver and evaluates a driving behavior of the driver on the basis of the information, and
the execution part causes an output part of the vehicle to output an evaluation result of the judgment part and/or transmits the evaluation result to a second information terminal used by the driver.

5. The driving assistance device according to claim 4, wherein the execution part acquires a result of secondary evaluation, in which the specific person evaluates the behavior of the driver, from the information terminal and causes the output part of the vehicle to output the result of the secondary evaluation and/or transmits the result of the secondary evaluation to the second information terminal.

6. The driving assistance device according to claim 1, wherein in a case where a location where the warning has been activated in the past is on a normal route, the execution part outputs a cautionary reminder before departure to a destination or near the location where the warning has been activated.

7. The driving assistance device according to claim 1, further comprising:
a storage part that stores road map information,
wherein the execution part stores, in the storage unit, road environment information related to a location where the warning has been activated in a case where the warning has been activated in a first traveled route and outputs a cautionary reminder at a point similar to the location where the warning has been activated in a case where a road environment of a second route to be traveled on next time is similar to the road environment information stored in the storage part.

8. The driving assistance device according to claim 1, wherein in a case where the judgment part determines that the driver is not responding to the task, the execution part executes control to switch a driving mode determined by the mode determination part to a driving mode in which functions are limited and cause the driver to cancel a function limitation by causing a shift lever to be positioned in a non-traveling range or a reverse range.

9. A driving assistance method comprising, by a computer:
recognizing a surrounding situation of a vehicle;
controlling one of or both acceleration/deceleration and steering of the vehicle;
determining a driving mode in which the vehicle is caused to travel with any of a plurality of kinds of driving assistance imposing different tasks on a driver;
determining whether or not the driver is responding to the task;
activating a warning in a case where it is determined that the driver is not responding to the task; and
transmitting information related to a behavior of the driver at a predetermined time before and/or after the warning is activated along with warning information to an information terminal used by a specific person associated with the driver.

10. A program that causes a computer to
recognize a surrounding situation of a vehicle;
control one of or both acceleration/deceleration and steering of the vehicle;
determine a driving mode in which the vehicle is caused to travel with any of a plurality of kinds of driving assistance imposing different tasks on a driver;
judge whether or not the driver is responding to the task;
activate a warning in a case where it is determined that the driver is not responding to the task; and
transmit information related to a behavior of the driver at a predetermined time before and/or after the warning is activated along with warning information to an information terminal used by a specific person associated with the driver.
